(19) United States
(12) Patent Application Publication
(10) Pub. No.: US 2004/0006492 A1
(43) Pub. Date: Jan. 8, 2004

(54) Health care service system

(75) Inventor: Motohisa Watanabe, Kawasaki-shi (JP)

Correspondence Address: FOLEY AND LARDNER, SUITE 500, 3000 K STREET NW, WASHINGTON, DC, 20007, US

(73) Assignee: NEC Infrontia Corporation

(21) Appl. No.: 10/353,074

(22) Filed: Jan. 29, 2003

(30) Foreign Application Priority Data
Jan. 30, 2002 (JP) 21958/2002

(51) Int. Cl. G06F 17/60

(52) U.S. Cl. 705/2; 455/422.1

(57) ABSTRACT

In a health care service system, an individual carrying a sensor and having a mobile telephone terminal (2) connected to the sensor and a health care service institution (3, 4) are preliminarily registered in a host computer (10) of a health care center (1). The host computer receives and monitors a sensor measurement value measured by the sensor and contained in personal data transmitted from the mobile telephone terminal through a communication network (5, 6). The host computer preliminarily stores a reference value for each item monitored by the sensor, compares the sensor measurement value and the reference value. Upon detecting an abnormality, the host computer transmits an abnormality warning to the mobile telephone terminal and the above-mentioned data to the health care service institution and requests the health care service institution to deal with the abnormality.

### BACKGROUND OF THE INVENTION

This invention relates to a system for providing a health care service in which an individual carrying a sensor with him for the purpose of health care and possessing a mobile telephone terminal connected to the sensor is registered with a health care center and the health care center remotely monitors through a network a sensor measurement value measured by the sensor of the individual as a registered member and transmitted from the mobile telephone terminal. Particularly, this invention relates to a health care service system capable of taking a variety of actions and measures in a shortest time in case where an abnormal condition occurs in health of an individual using a mobile telephone terminal.

As a conventional health care service system using a mobile telephone terminal of the type, a medical information radio transmission system is disclosed in Japanese Unexamined Patent Publication No. H08-329374 (JP 8-329374 A).

In the above-referenced system, a center unit is responsive to a position detection signal transmitted from a mobile radio telephone set (mobile telephone terminal) and detects a current position of the mobile radio telephone set. In addition, a sensor implanted in a body of a patient detects biological information of the patient, such as a pulse rate and a blood pressure related to his heart. The mobile radio telephone set is regularly or periodically supplied with the biological information from the sensor and transmits the biological information to the center unit. The center unit analyzes the biological information to judge whether or not an emergency (abnormality) in health occurs. If the occurrence of emergency is judged, the center unit informs the mobile radio telephone set of an emergency message and some assisting information such as a name of a hospital located near to the current position of the mobile radio telephone set.

Thus, upon occurrence of the abnormality in health of the patient, the center unit can communicate with the mobile radio telephone set to confirm a physical condition of the patient in detail through a telephone interview with the patient.

However, in the above-mentioned medical information radio transmission system as the conventional health care service system using the mobile telephone terminal, the center unit only informs the patient of the emergency message and the name of the hospital near to the current position of the mobile radio telephone set upon occurrence of the abnormality in his health. It is difficult to immediately and appropriately deal with the abnormality in health of the patient.

Japanese Unexamined Patent Publication No. H11-112695 (JP 11-112695) discloses an emergency call system. When a possessor (patient) of a mobile telephone set depresses an emergency button of the mobile telephone set to originate an emergency call, the mobile telephone set transmits, to an emergency call center, position information of the mobile telephone set obtained from a signal from a GPS (Global Positioning System) satellite and a possessor ID assigned to the mobile telephone set. The emergency call center is responsive to the position information and informs a hospital or a fire department of reception of the emergency call.

However, in case of the emergency call transmitted by depressing the emergency button, the patient is not supplied from the emergency call center with any response or acknowledgement of reception of the emergency call. Therefore, the patient who has transmitted the emergency call inevitably feels uneasy or anxious.

On the other hand, the emergency call center merely informs the hospital or the fire department of reception of the emergency call in response to the position information. In other words, the emergency call center does not send any data related to a current condition of the patient to the hospital or the fire department. Therefore, it is difficult for the hospital or the fire department to immediately and appropriately deal with the abnormality in health of the patient.

Japanese Unexamined Patent Publication No. 2000-139857 (JP 2000-139857 A) discloses a system including a wristwatch-type radio telephone set having a function of measuring a blood pressure and a heart rate of a user (patient), a center server for collecting measured data and automatically making a diagnosis on the measured data, and an emergency call center for directly communicating with the user (patient) upon occurrence of an abnormality in the measured data. If the user (patient) can not be contacted, the emergency call center arranges for an ambulance.

However, in this system also, the emergency call center can not send the data related to a current condition of the patient to the ambulance or a hospital although the ambulance is arranged. Therefore, it is difficult for the ambulance or the hospital to immediately and appropriately deal with the abnormality of the patient.

Furthermore, the above-mentioned publication does not describe that the wristwatch-type radio telephone set has an emergency button for transmitting an emergency call.

Japanese Unexamined Patent Publication No. 2001-67403 (JP 2001-67403 A) discloses a home health care system. A member requesting health care measures and enters daily health data by the use of a home terminal unit installed at his home. On the other hand, a terminal unit installed in each of a health care center and a medical institution continuously monitors the daily health data. Through bi-directional communication, health and medical advices are given if necessary and appropriate. Upon detection of an abnormality, the medical institution remotely provides medical care. Depending upon the circumstance, medical staff urgently visits the home of the member to take a medical procedure or step.

However, the above-mentioned system offers home medical care in which the medical staff urgently visits the home of the member to take the medical procedure upon detection of the abnormality. As compared with the case where the patient is taken to a hospital by an ambulance and subjected to the medical procedure in the hospital, available medical instruments and medical steps are restricted so that an appropriate medical treatment is difficult to be given. For a sufficient and appropriate medical treatment, the patient must be taken by an ambulance to a hospital provided with many kinds of medical instruments after the home medical care has been carried out.

### SUMMARY OF THE INVENTION

It is therefore an object of this invention to provide a health care service system using a mobile telephone terminal, which is capable of immediately and appropriately dealing with an abnormality in health of a patient.

It is another object of this invention to provide a health care service system using a mobile telephone terminal, which is capable of making a patient, who has transmitted an emergency call to a health care center by depressing an emergency button, feel easy or assured by sending a response or acknowledgement of reception of the emergency call from the health care center to the patient.

According to this invention, there is provided a health care service system in which an individual carrying a sensor for health care and having a mobile telephone terminal connected to the sensor and a health care service institution such as a hospital are preliminarily registered in a host computer of a health care center, the host computer of the health care center receiving and monitoring a sensor measurement value measured by the sensor and contained in data transmitted from the mobile telephone terminal through a communication network;

the host computer of the health care center preliminarily storing a reference value for each item monitored by the sensor, comparing the sensor measurement value and the reference value upon reception of the sensor measurement value from the mobile telephone terminal, and, upon detecting an abnormality, transmitting an abnormality warning to the mobile telephone terminal and the above-mentioned data to the health care service institution preliminarily registered and requesting the health care service institution to deal with the abnormality.

According to this invention, there is also provided a health care service system in which an individual carrying a sensor for health care and having a mobile telephone terminal connected to the sensor and a health care service institution such as a hospital are preliminarily registered in a host computer of a health care center, the host computer of the health care center receiving and monitoring a sensor measurement value measured by the sensor and contained in data transmitted from the mobile telephone terminal through a communication network;

the host computer of the health care center preliminarily storing a reference value for each item monitored by the sensor, comparing the sensor measurement value and the reference value upon reception of the sensor measurement value from the mobile telephone terminal, transmitting, upon detecting an abnormality, an abnormality warning to the mobile telephone terminal and the above-mentioned data to the health care service institution preliminarily registered, and requesting the health care service institution to deal with the abnormality;

the mobile telephone terminal having an emergency report button for transmitting an emergency report when it is operated, the mobile telephone terminal transmitting, as the above-mentioned data, the sensor measurement value together with the emergency report when the emergency report button is operated by the individual;

the host computer immediately sending back, upon reception of the data including the emergency report, an acknowledgement of reception of the emergency report to the mobile telephone terminal, comparing the sensor measurement value and the reference value, informing, upon detecting no abnormality, the mobile telephone terminal as a caller of no abnormality being detected with respect to the emergency report, and, upon detection of an abnormality, transmitting the above-mentioned data to the health care service institution preliminarily registered and requesting the health care service institution to deal with the emergency report from the mobile telephone terminal.

### BRIEF DESCRIPTION OF THE DRAWING

FIG. 1 is a view showing a health care service system according to one embodiment of this invention;

FIG. 2 is a view showing a database in a host computer illustrated in FIG. 1;

FIG. 3 is a functional block diagram of a mobile telephone terminal illustrated in FIG. 1;

FIG. 4 is a flow chart for describing an operation of registering personal information by the mobile telephone terminal;

FIG. 5 is a sequence chart for describing an operation of registering institution information by a relevant institution;

FIG. 6 is a sequence chart for describing an operation of monitoring sensor measurement values regularly transmitted by the mobile telephone terminal;

FIG. 7 is a sequence chart for describing an operation in case where an emergency button of the mobile telephone terminal is operated;

FIG. 8 is a view showing a modification of the database illustrated in FIG. 2;

FIG. 9 is a sequence chart for describing an operation of registering additional personal information by a hospital;

FIG. 10 is a flow chart for describing a first part of operation of monitoring sensor measurement values regularly transmitted by the mobile telephone terminal by the use of the database illustrated in FIG. 8; and

FIG. 11 is a flow chart for describing a second part of operation following the first part in FIG. 10.

### DESCRIPTION OF THE PREFERRED EMBODIMENT

Now, description will be made of an embodiment of this invention with reference to the drawing.

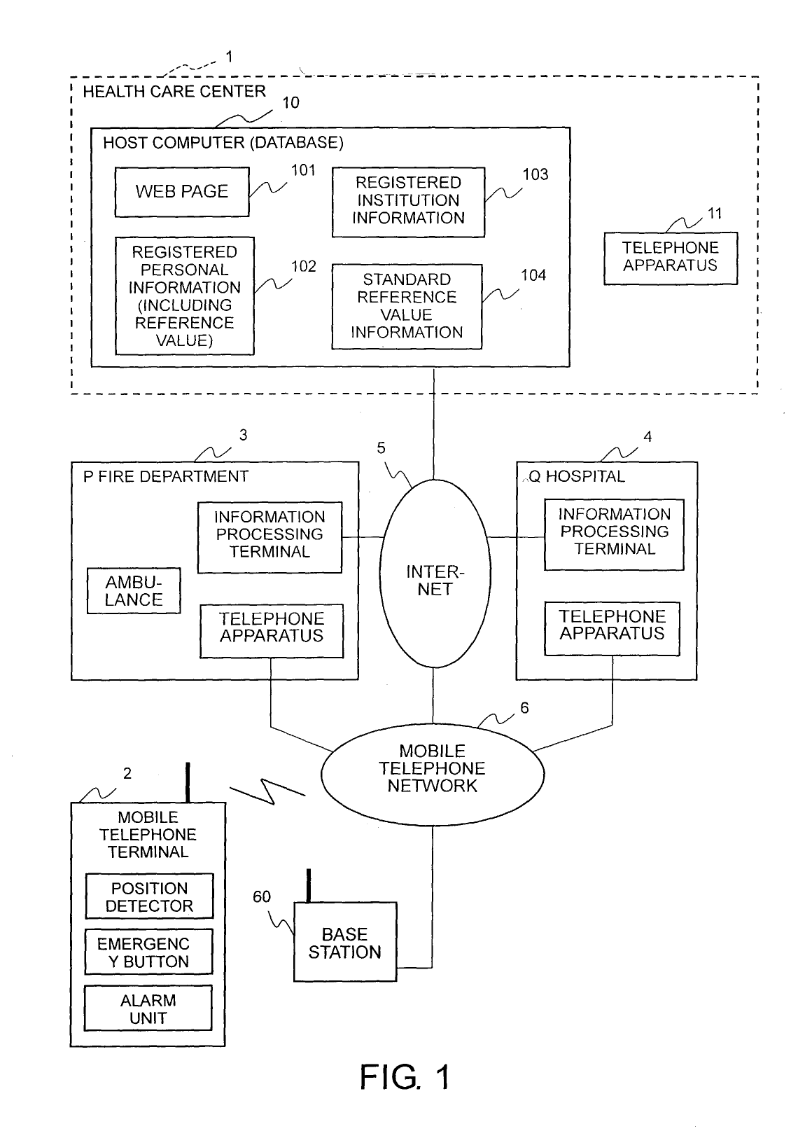

Referring to FIG. 1, a health care service system using a mobile telephone terminal includes a health care center 1, a mobile telephone terminal 2, a P fire department 3 as a first registered institution, and a Q hospital 4 as a second registered institution. The health care center 1, the mobile telephone terminal 2, the P fire department 3, and the Q hospital 4 are communicable with one another through networks such as the Internet 5 and a mobile telephone network 6. Therefore, each of the health care center 1, the mobile telephone terminal 2, the P fire department 3, and the Q hospital 4 has, at relevant sections, functions of an information processing apparatus and a telephone apparatus connected to the Internet 5 and the mobile telephone network 6, respectively, and is assigned with an electronic mail address and a telephone number.

It is assumed here that each individual or each institution registered in the health care service system has an electronic mail system capable of carrying out an interrupting call announcement by caller identification well known in the art. Specifically, each of an information processing terminal and a communication terminal, which can be connected to the Internet, is continuously turned on and is capable of identifying a sender of an electronic mail to classify the electronic mail and changing announcing means, such as an audible call tone. Therefore, when reception of the electronic mail is announced at the terminal in this system, it is possible to detect an abnormality or an emergency.

The health care center 1 has a host computer 10 directly connected to the Internet 5 and a telephone apparatus 11 directly or indirectly connected to the mobile telephone network 6. The mobile telephone terminal 2 is connected to the mobile telephone network 6 via radio communication with a base station 60 near to the mobile telephone terminal 2. Each of the P fire department 3 and the Q hospital 4 can be connected directly or indirectly to the Internet 5 or the mobile telephone network 6.

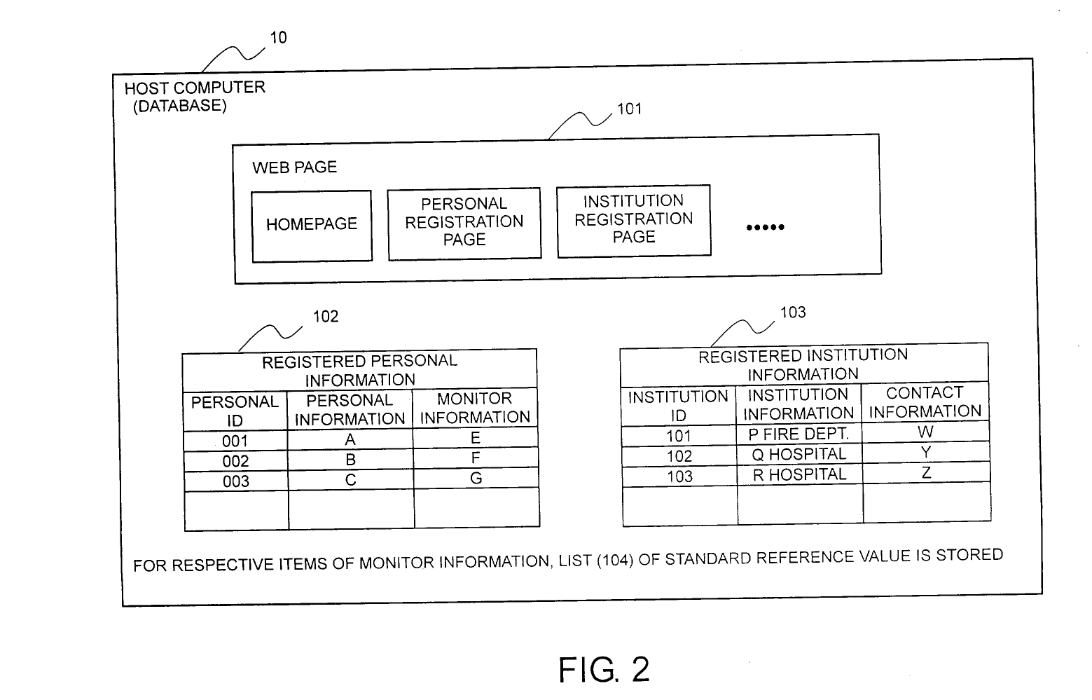

Referring to FIG. 2 in addition to FIG. 1, the host computer 10 has a database which stores a web page 101, registered personal information 102, registered institution information 103, and standard reference value information 104.

The web page 101 includes a homepage set up on the Internet 5 and various web pages linking from the homepage, such as a new registration page for an individual, a new registration page for an institution, a registered member page which can be opened by a registered member, i.e., a registered individual or a registered institution already registered with the health care center 1. These web pages are prepared in the health care center 1 and stored in the host computer 10. Each of the web pages is assigned with a URL (Uniform Recaller Locator) for access via the Internet.

The registered personal information 102 contains a personal ID (identifier), personal information, and monitor information for each of the registered individuals. The personal ID is assigned to each individual upon registration and used to identify the registered individual for login to the web page 101. The personal information includes the name, the age, the address of each individual who uses or receives a health care service, the telephone number of his mobile telephone terminal, and the electronic mail address. The personal information is entered by the individual upon registration. The monitor information includes a reference value for each item to be monitored by a sensor carried by the individual, for example, a heart-related item such as a blood pressure and a pulse rate. The reference value is entered by the individual upon registration and used in judgment of an abnormality for each item. In absence of the entry of the reference value of the monitor information, a standard reference value in the standard reference value information 104 is used as the reference value.

The host computer 10 has a memory (not shown) for temporarily storing a sensor measurement value supplied from the mobile telephone terminal 2. Alternatively, the registered personal information 102 may have an area where the sensor measurement value is stored and updated every time when it is received.

The registered institution information 103 contains an institution ID, institution information, and contact address information for each of the registered institutions including the P fire department 3 requested to send an ambulance and the Q hospital 4 responsible to an individual patient. The institution ID is assigned to the institution upon registration and used to identify the registered institution for login to the web page 101. The institution information contains the name, the address, the telephone number, and the electronic mail address of each institution registered with the health care service. The institution information is entered by each institution upon registration. The contact address information is an electronic mail address or a telephone number of a contact section in the institution such as the hospital, which can be called in a special mode to receive the sensor measurement value. The contact address information is entered by each institution upon registration.

The standard reference value information 104 contains a list of standard reference values to find any abnormality for respective items detected by the sensor. In absence of the reference value in the monitor information of the registered personal information 102, the sensor measurement value supplied from the mobile telephone terminal 2 is compared with the standard reference value to judge an abnormality.

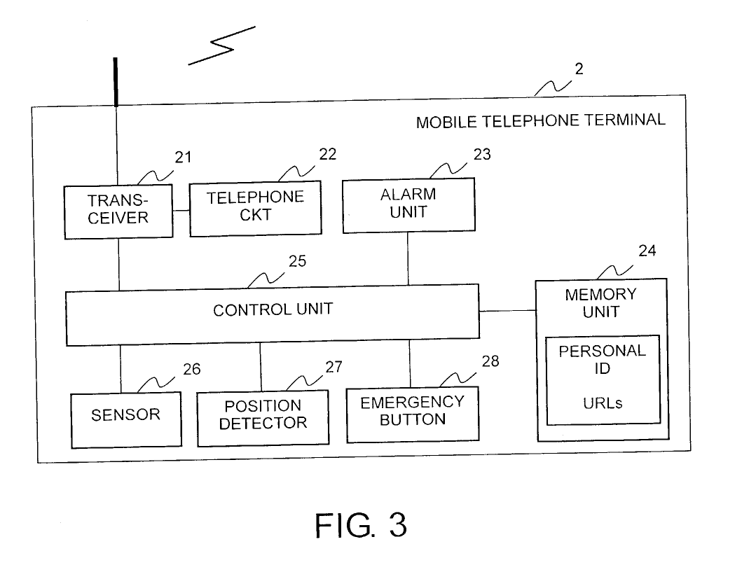

Referring to FIG. 3 in addition to FIG. 1, description will be made of the mobile telephone terminal 2.

The mobile telephone terminal 2 has a transceiver 21, a telephone circuit 22, an alarm unit 23, a memory unit 24, a control unit 25, a sensor 26, a position detector 27, and an emergency button 28. A dial pad for entry of numerals and characters, keys and buttons for designating various functions, and a display window for displaying a message, which are essential components of the mobile telephone terminal, are not shown in the figure. The mobile telephone terminal 2 can identify a caller of an incoming call and is ready to produce a special call tone or an alarm sound different from an ordinary call tone when the incoming call is received from the health care center 1 or the registered institution by an electronic mail or a telephone.

The transceiver 21 is an equipment for radio communication with the base station 60 of the mobile telephone network 6 and carries out transmission and reception of data, including speech, to and from the mobile telephone network 6 and the Internet 5. The telephone circuit 22 has a telephony function including a number dial, a handset, and generation of a call tone upon call reception. The alarm unit 23 cooperates with the control unit 25 and generates an alarm sound in response to an electronic mail indicating the health care center 1 as a caller address. The alarm unit 23 may generate an alarm sound in response to an electronic mail indicating a responsible hospital as a caller address. In addition to a program and a temporary memory for execution of the program, the memory unit 24 stores the personal ID supplied from the health care center 1 and the URL prepared in the host computer 10 to access to the web page.

The control unit 25 controls the functions of the mobile telephone terminal 2 by the use of the program. The operation of the mobile telephone terminal 2 will later be described with reference to the drawing.

For example, the sensor 26 receives, as a radio wave, detected data transmitted from the sensor implanted in a body of the registered individual as a patient. Under control of the control unit 25, the transceiver 21 sends the detected data as the sensor measurement value for each item regularly or periodically to the host computer 10 by accessing to a predetermined URL on the Internet 5.

The position detector 27 serves to detect a current position of the mobile telephone terminal 2. For example, the current position on the earth is detected by the GPS (Global Positioning System). Alternatively, in a portable handy-phone system (PHS), it is possible to detect the current position as a small region with reference to the position of the base station communicating with the mobile telephone terminal. Alternatively, use may be made of a mobile terminal location detecting system in which the mobile telephone network 6 is responsive to a request from the mobile telephone terminal 2, calculates a plurality of distances between the mobile telephone terminal 2 and a plurality of base stations 60 around the mobile telephone terminal 2, obtains the current position as an intersecting point of a plurality of circles having radii equal to the above-mentioned distances and centered at the base stations 60, and informs the current position to the mobile telephone terminal 2.

The emergency button 28 is depressed by the patient upon occurrence of an emergency to inform the emergency to the health care center 1. If necessary, it is possible to request for an ambulance from the fire department or medical staff from the hospital.

As the registered institutions, the P fire department 3 and the Q hospital 4 are illustrated in FIG. 1. A police station may be registered. These registered institutions are located within one local area. In response to a call with respect to the mobile telephone terminal 2, the health care center 1 selects an appropriate one of the registered institutions in dependence upon an emergency degree of the patient. For example, the P fire department is selected to request for the ambulance. The Q hospital is selected for a medical advice. In case of a wide area or in case of special hospitals, a plurality of hospitals are registered as shown in FIG. 2. For example, in case of a nationwide service, position information of the mobile telephone terminal 2 is essential and the fire department may be replaced by an emergency number or an ambulance call number (“119” in Japan). The information processing terminal and the telephone apparatus In the registered institution to be called by the health care center 1 are continuously turned on. A call tone can be selected to be an alarm sound distinguishable from other tones.

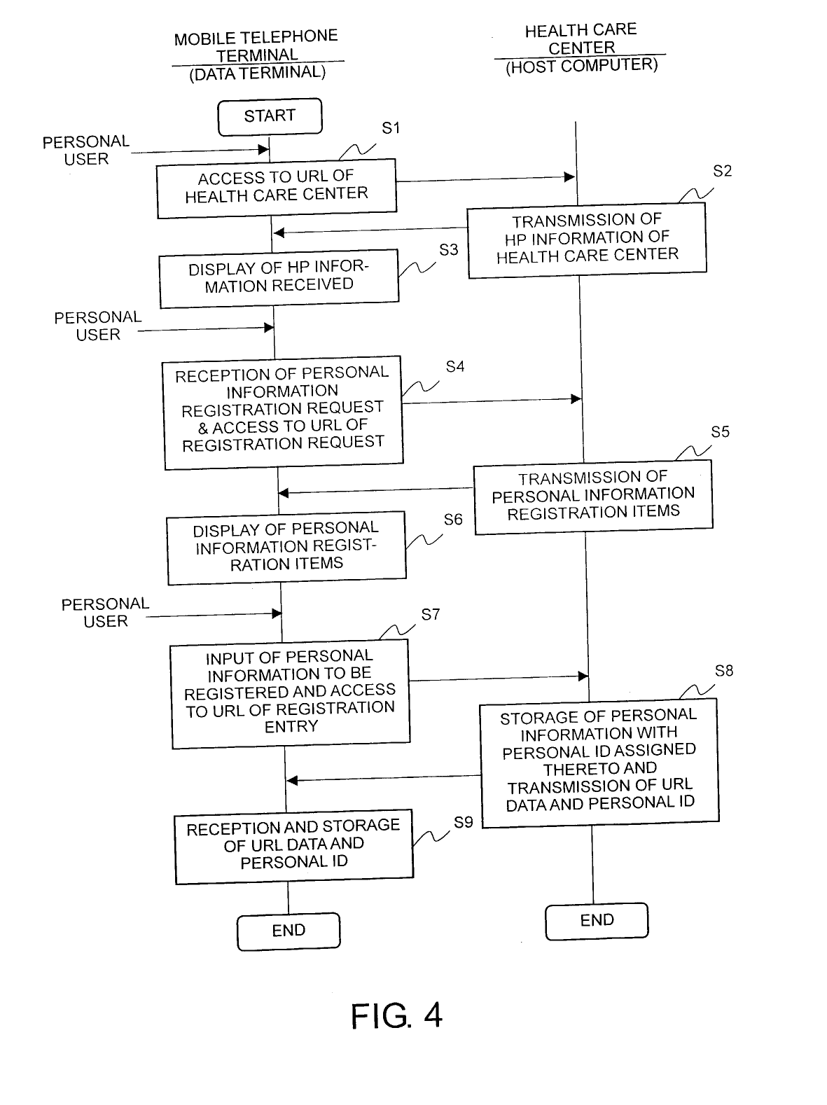

Next referring to FIG. 4 in addition to FIGS. 1 and 2, description will be made of an operation of registering a personal user with the health care center 1. The personal user as a patient is preliminarily informed of the URL of the health care center 1 with which the personal user is to be registered.

By an input operation of the personal user, the mobile telephone terminal 2 accesses to the URL of the health care center 1 (step S1) to browse the homepage. In the health care center 1, the host computer 10 as a server transmits homepage (HP) information corresponding to the URL (step S2) to the mobile telephone terminal 2 as a caller. As a consequence, the mobile telephone terminal 2 receives the homepage information and displays the homepage (step S3). The homepage has buttons for requesting information registration of an individual and an institution to join the health care service and links to personal and institution registration pages as linking web pages.

When the personal user selects a personal information registration request on the homepage displayed on the mobile telephone terminal 2 and enters the request by an enter key, the mobile telephone terminal 2 accesses to a URL of the linking web page as the personal registration page having personal information registration items (step S4). In response to the access, the host computer 10 transmits personal information registration page information to the mobile telephone terminal 2 as the caller (step S5). As a consequence, at the mobile telephone terminal 2, the personal information registration items are displayed on the display window (step S6). As described above, the registration items comprise a various kinds of personal information, including the name, the age, the address of the individual who uses the health care service, the telephone number of his mobile telephone terminal, and the electronic mail address.

When the personal user inserts, as personal information, respective data in the personal information registration items on the personal information registration page displayed on the mobile telephone terminal 2 and enters the data by the enter key, the mobile telephone terminal 2 accesses to a URL of a personal information registration entry linking from the web page (or a personal registration page) (step S7). Supplied with the personal information to be registered, the host computer 10 records and stores the personal information in the registered personal information 102 of the database and transmits to the mobile telephone terminal 2 as the caller a registration end message, a personal ID assigned to the personal information stored in the database, and a related URL to be accessed by the personal user as a registered personal user (step S8). As a consequence, the mobile telephone terminal 2 receives the registration end message, the personal ID, and the related URL and stores the personal ID and the related URL (step S9). Thus, the registering operation comes to an end.

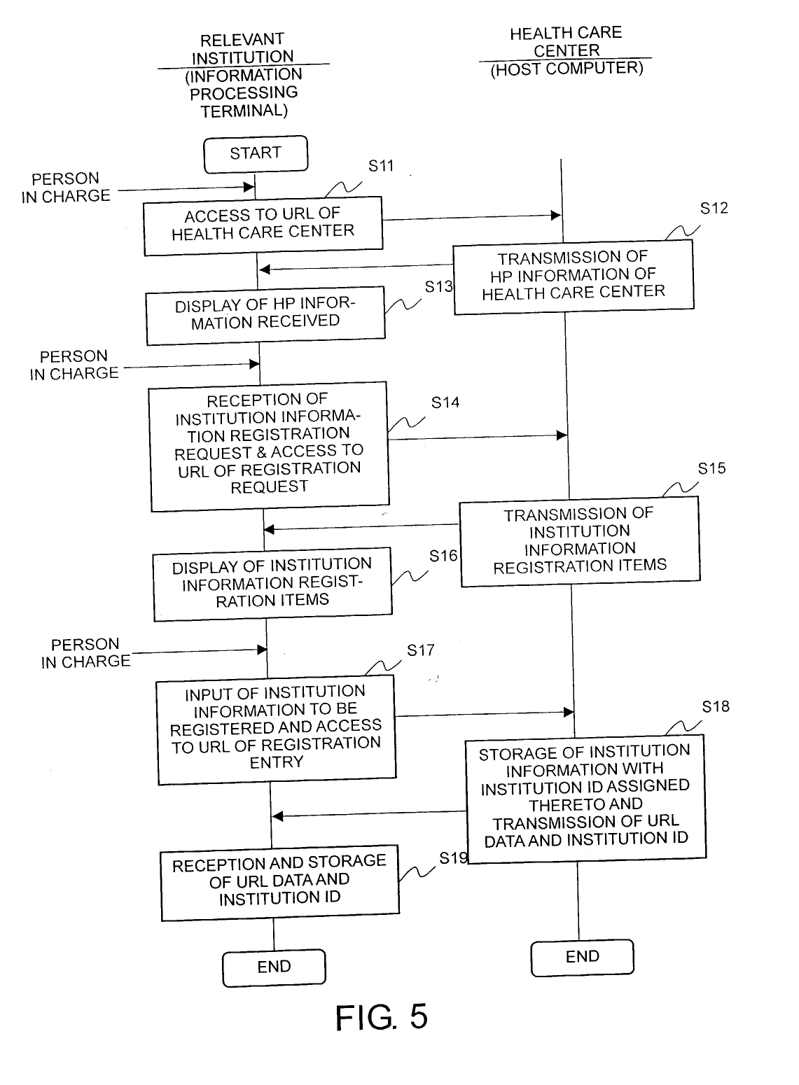

Next referring to FIG. 5 in addition to FIGS. 1 and 2, description will be made of an operation of registering an institution, such as a hospital, with the health care center 1. The institution is preliminarily informed of the URL of the health care center 1 with which the institution is to be registered.

The registering operation by the institution is similar to the registering operation by the personal user described in conjunction with FIG. 4. Specifically, the steps S11 to S19 in FIG. 5 are similar to the steps S1 to S9 in FIG. 4 except that the personal user, the personal information, and the personal ID are replaced by a person in charge in the institution, the institution information, and the institution ID, respectively. As described above, the institution information includes the name, the address, the telephone number, and the electronic mail address of the institution registered with the health care center 1.

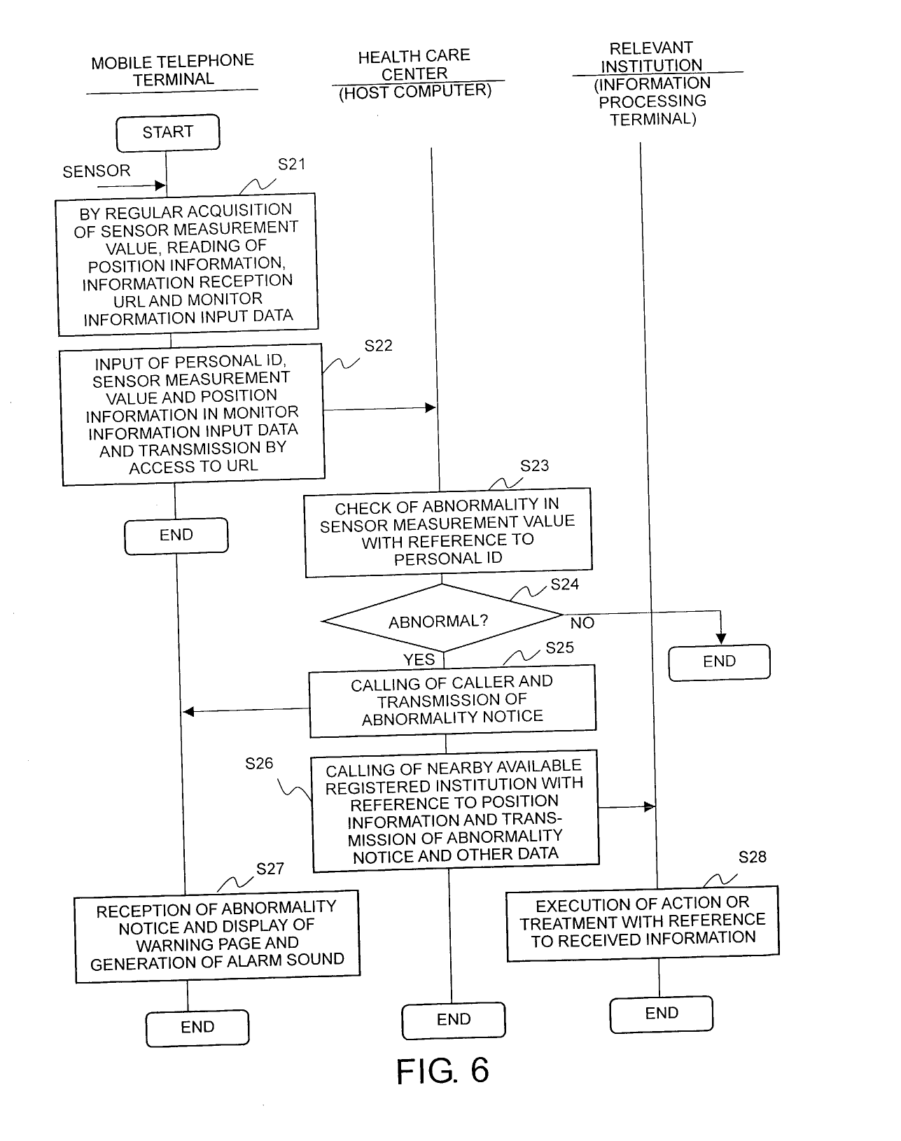

Next referring to FIG. 6 in addition to FIGS. 1 through 3, description will be made of an operation of transmitting the sensor measurement value detected by the sensor 26 of the mobile telephone terminal 2 to the health care center 1 for physical examination.

The mobile telephone terminal 2 acquires the sensor measurement value measured by the sensor 26 in a predetermined manner, for example, regularly or periodically, detects as position information the current position of the mobile telephone terminal 2 by the position detector 27, and reads the personal ID, an information input reception URL, and monitor information input data stored in the mobile telephone terminal 2 (step S21). The mobile telephone terminal 2 inserts the personal ID, the sensor measurement value, and the position information to predetermined positions of the monitor information input data, accesses to the information input reception URL, and transmits the above-mentioned data to the host computer 10 of the health care center 1 (step S22).

With reference to the personal ID supplied from the mobile telephone terminal 2, the host computer 10 compares the sensor measurement value with the reference value obtained from the registered personal information 102 to check whether or not any abnormality occurs in the sensor measurement value (step S23). In case where the reference value is not registered as the personal information in the registered personal information 102, the standard reference value obtained from the standard reference value information 104 is used for comparison. If no abnormality is detected as a result of checking (NO in step S24), the operation comes to an end.

If it is judged that the sensor measurement value is abnormal (YES in step S24), the host computer 10 immediately transmits an abnormality notice to the mobile telephone terminal 2 as the caller (step S25). Then, with reference to the position information received from the mobile telephone terminal 2, the host computer 10 searches the registered institution information 103 with reference to the position information supplied thereto to select, as a selected registered institution, an appropriate one of the registered institutions which is located near to the current position of the mobile telephone terminal 2 and which is adapted to cope with the abnormal sensor measurement value. The host computer 10 calls the selected registered institution as a called registered institution and transmits the position information of the mobile telephone terminal 2 in consideration, the personal information, and the sensor measurement value to the called registered institution (step S26).

In a case where the sensor measurement value is abnormal, the degree of abnormality is also judged. For brevity of description, however, the degree of emergency is simply mentioned and the detail of judgement of the degree of abnormality will be omitted.

In another case where no sensor measurement value is contained in the received data, the host computer 10 may call the mobile telephone terminal 2 as an emergent abnormality to warn the abnormality and notifies the situation to the health care service institution preliminarily registered to request a countermeasure against the situation.

By the above-mentioned step S25, the mobile telephone terminal 2 receives an emergency call by the abnormality notice and responds to the emergency call so that an alarm announcement is immediately received (step S27). The called registered institution called in the above-mentioned step S26 may be a fire department which is requested to send an ambulance if the degree of emergency is high and may be a hospital adapted to deal with the abnormality in a heart system or a respiratory system if the degree of emergency is low. Supplied from the host computer 10 of the health care center 1 with the position information, the personal information, and the sensor measurement value as received information, the called registered institution executes an optimal action or treatment with reference to the contents of the received information (step S28).

For example, the optimal action is as follows. If the called registered institution is the P fire department 3, the P fire department 3 sends the ambulance with reference to the position information supplied thereto. The ambulance delivers the patient to a nearest emergency hospital with reference to other information, such as the abnormality in the sensor measurement value and the personal information. If the called registered institution is the Q hospital 4, the Q hospital 4 calls the mobile telephone terminal 2 of the patient to advise an appropriate treatment if it is required. If an emergent rescue is required, the Q hospital 4 requests to send an ambulance to take the patient and, if necessary, sends medical staff to the place where the patient is present.

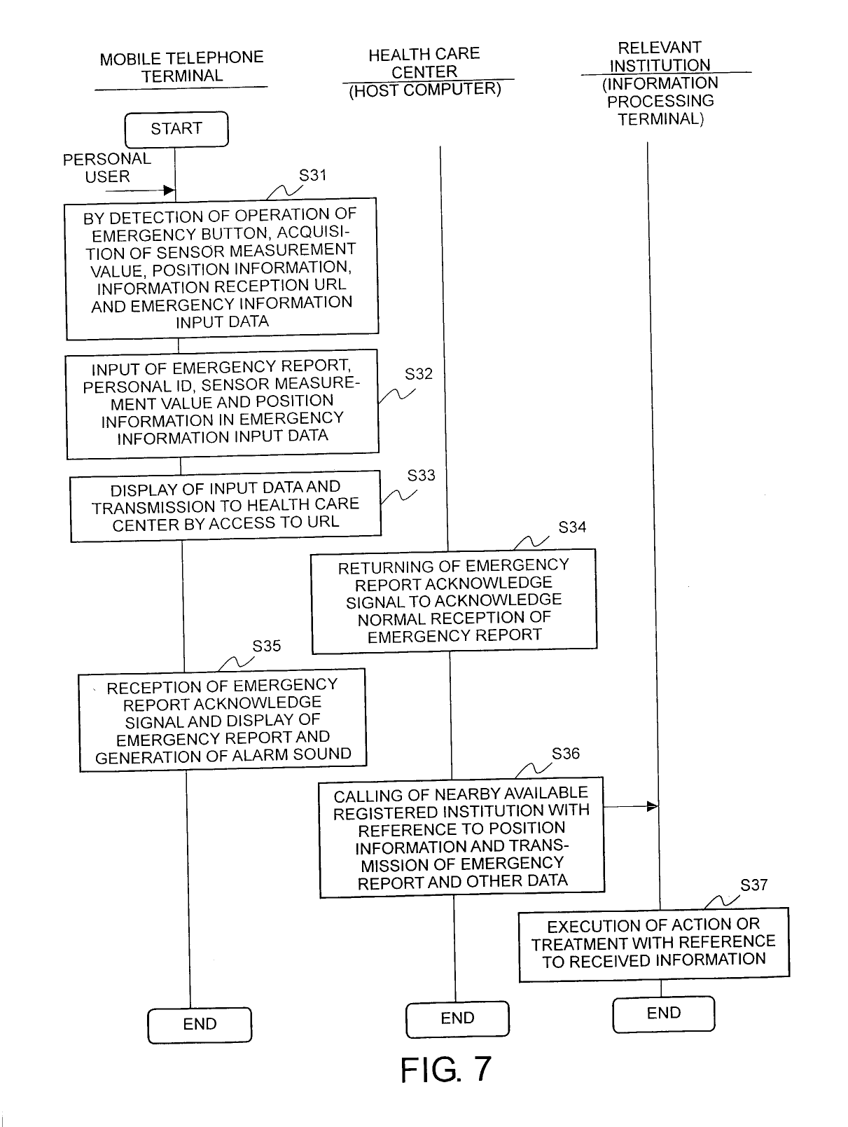

Next referring to FIG. 7 in addition to FIGS. 1 through 3, description will be made of an operation in case where the registered individual as the patient feels an abnormality in his health and depresses the emergency button 26 of the mobile telephone terminal 2.

When it is detected that the emergency button 26 is depressed, the mobile telephone terminal 2 acquires the sensor measurement value measured by the sensor 26 and the current position information detected by the position detector 27 at that time instant and reads out and displays the information input reception URL and the monitor information input data stored in the mobile telephone terminal 2 (step S31). In the monitor information input data being displayed, the mobile telephone terminal 2 inserts an emergency report, the personal ID, the sensor measurement value, and the position information at predetermined positions (step S32) to display these data. The mobile telephone terminal 2 accesses to the information input reception URL to transmit these data (step S33).

The host computer 10 of the health care center 1 confirms normal reception of the emergency report and returns an emergency report acknowledge signal to the mobile telephone terminal 2 as a caller (step S34). In response to the emergency call acknowledge signal, the mobile telephone terminal 2 displays a predetermined emergency report page and controls the alarm unit 23 to generate an alarm sound (step S35). From such visible and audible information, the patient or the personal user possessing the mobile telephone terminal 2 can confirm that the emergency report is received by the health care center 1 and feels easy or assured for the time being.

Following the above-mentioned step S34, the host computer 10 searches the registered institution information 103 with reference to the position information supplied thereto to select, as a selected registered institution, an appropriate one of the registered institutions which is located near to the current position of the mobile telephone terminal 2 and which is adapted to cope with the abnormal sensor measurement value. The host computer 10 calls the selected registered institution as a called registered institution and transmits the emergency report of the mobile telephone terminal 2 in consideration, the position information, the personal information, and the sensor measurement value to the called registered institution (step S36). The called registered institution called in the above-mentioned step S36 may be a fire department which is requested to send an ambulance if the degree of emergency is high and may be a hospital adapted to deal with the abnormality in a heart system or a respiratory system if the degree of emergency is low. Supplied with the emergency report, the position information, the personal information, and the sensor measurement value as received information, the called registered institution executes an optimal action or treatment with reference to the contents of the received information (step S37).

For example, the above-mentioned service is operated by a contract in which an individual who desires health care applies for registration of his mobile telephone terminal with the health care service and pays a service charge and a health care charge to the health care center. Each registered institution receives payment from the health care center as an individual rescue charge or a medical treatment charge for an action or a medical procedure taken upon occurrence of an abnormality.

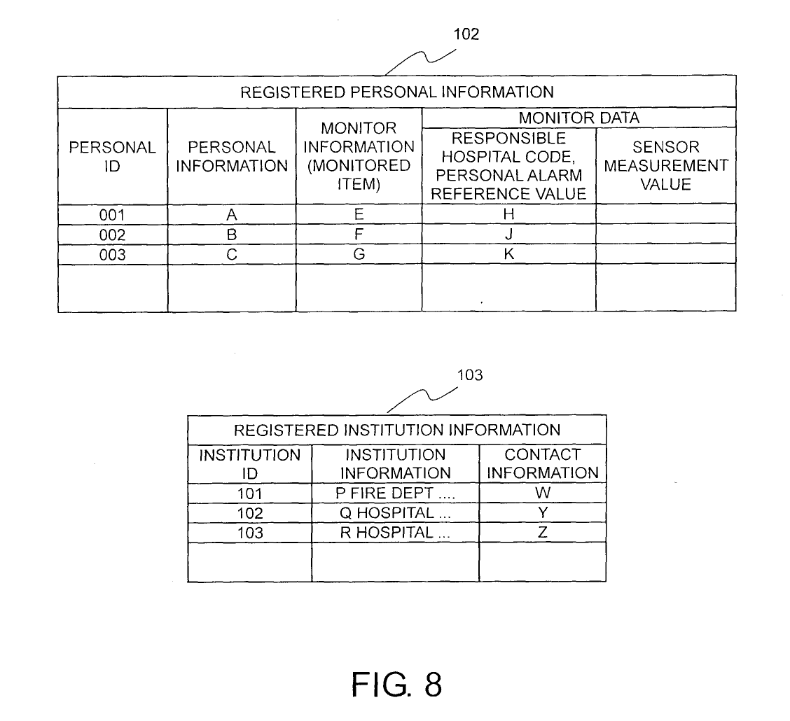

Next referring to FIG. 8, description will be made of a system in which the patient is monitored from a responsible hospital and is given a more sufficient health care service.

The registered personal information 102 illustrated in the figure contains monitor data entered by the hospital, in addition to the monitor information mainly containing personal monitored items. For example, the monitor data contain a responsible hospital code registered by the institution ID, an individual alarm reference value preliminarily decided by the responsible hospital with respect to each monitored item for the patient, and the sensor measurement value obtained by the sensor of the mobile telephone terminal 2 and updated every time when it is supplied therefrom. The individual alarm reference value is decided by a responsible doctor and registered in order to judge an abnormality in the sensor measurement value obtained for each monitored item of the patient.

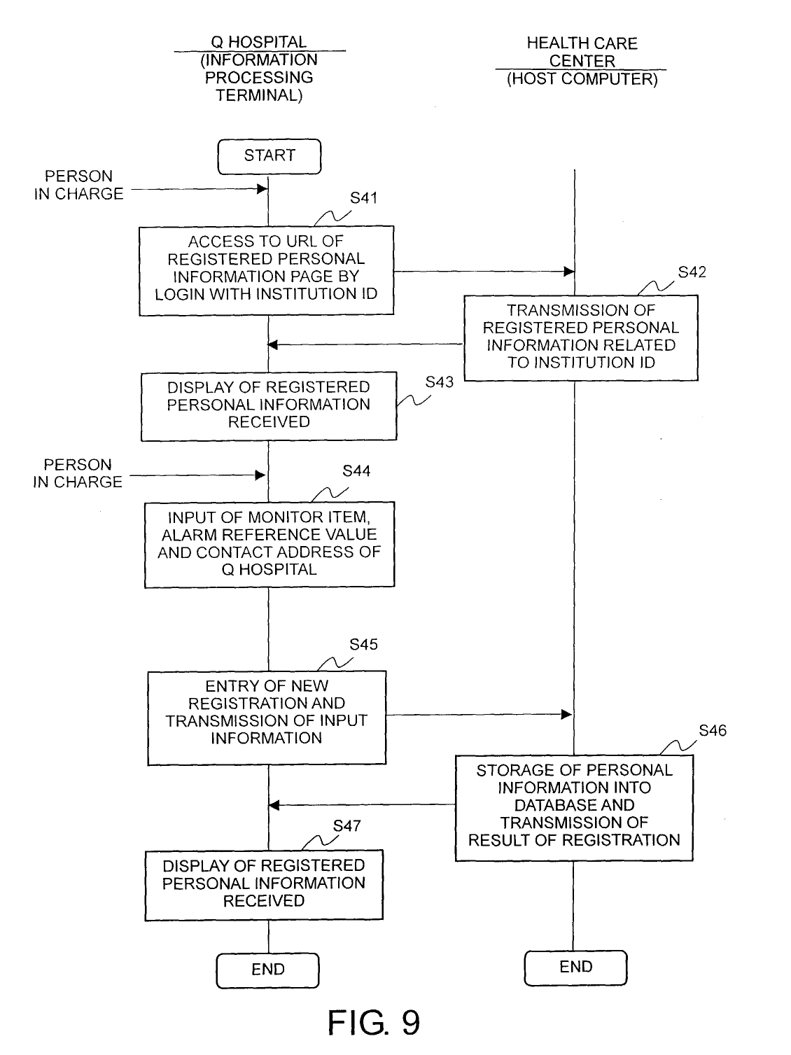

Referring to FIG. 9 in combination with FIGS. 1, 3, and 8, description will be made of an operation of registering the monitor data by the Q hospital 4 as the registered institution. It is assumed here that the registered personal information 102 and the registered institution information 103 described in conjunction with FIG. 2 are already registered.

By an input operation of a person in charge, the Q hospital 4 accesses to a URL of a registered personal information page of the health care center 1, which is already stored in the information processing terminal, by login using the institution ID (step S41). In the health care center 1, the host computer 10 as a server reads out the registered personal information 102 corresponding to the URL and transmits the registered personal information 102 to the Q hospital 4 as a caller (step S42). As a consequence, the Q hospital 4 receives and displays a page of the registered personal information 102 (step S43). The page of the registered personal information 102 has buttons for information registration requests for an individual and an institution registered with the health care service and links to the individual and the institution registration pages.

The person in charge in the Q hospital 4, which is to be called with respect to health care of the individual, inserts as input information the name or the institution ID of the Q hospital 4 as a responsible hospital code, the monitored items, and the personal alarm reference value for each item at predetermined positions of the page of the registered personal information of the individual who requires health care (step S44). When it is confirmed that an enter button is depressed for the input information inserted by the person in charge, the information processing terminal in the Q hospital 4 as the registered institution accesses to the above-mentioned URL and transmits the input information to the host computer 10 (step S45). The host computer 10 of the health care center 1 receives the input information as received personal information, registers and stores the received personal information in the registered personal information 102 of the database, and transmits the content of the registered personal information to the Q hospital 4 as a caller (step S46). The Q hospital 4 receives the content of the registered personal information and displays the content on the information processing terminal (step S47) to confirm the content.

Through the above-mentioned steps S41 to S43, a responsible doctor in the hospital can review the registered personal information of the patient by displaying it on the information processing terminal. It is therefore possible to effectively utilize the registered personal information for health care of the patient. If necessary, the registered personal information can be modified in the manner similar to new registration.

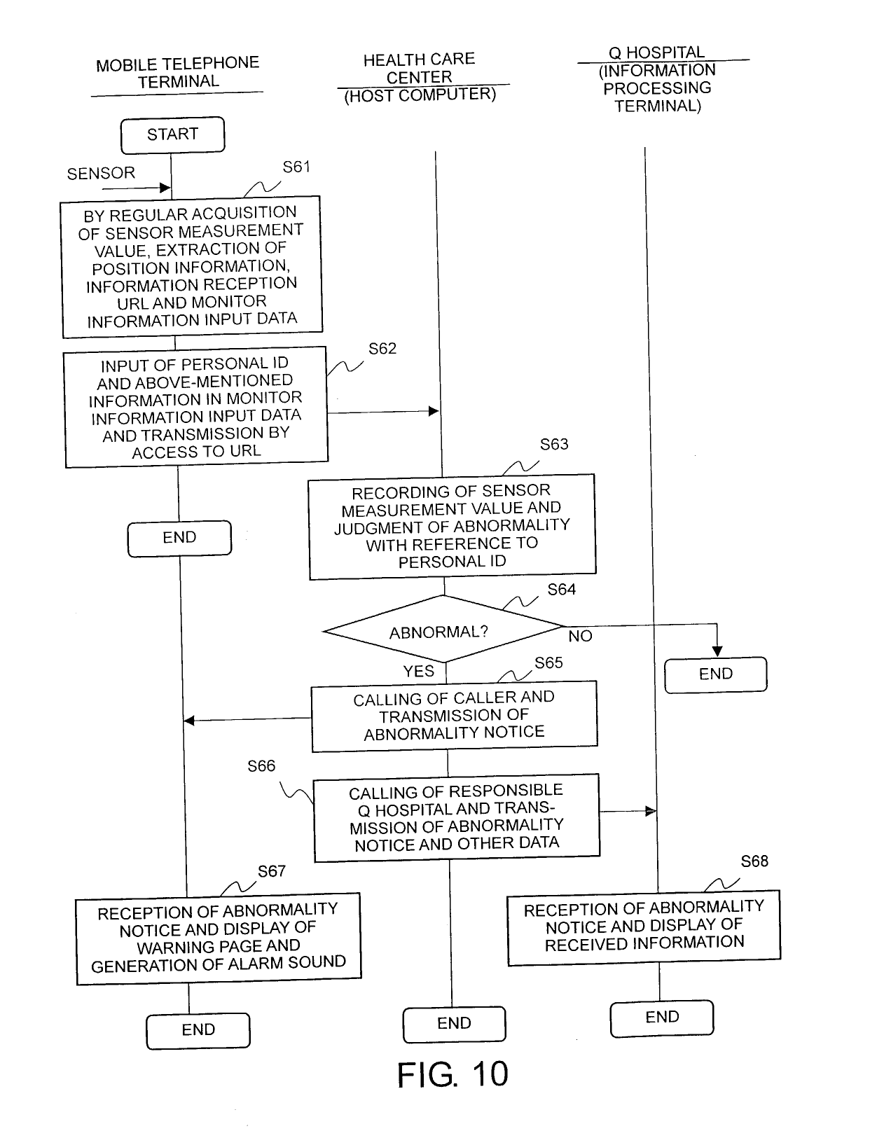

Next referring to FIG. 10 in addition to FIGS. 1, 3, and 8, description will be made of an operation of processing the sensor measurement value.

It is assumed that the mobile telephone terminal 2 has a personal ID “001” shown in FIG. 8 and that the Q hospital 4 is responsible to the patient possessing the mobile telephone terminal 2. Therefore, monitor data “H” in FIG. 8 for the mobile telephone terminal 2 include the institution ID “102” of the Q hospital 4 as the responsible hospital code and the individual alarm reference value of the patient.

In the manner similar to that mentioned in conjunction with FIG. 6, the mobile telephone terminal 2 acquires the sensor measurement value measured by the sensor 26 in a predetermined manner, for example, regularly or periodically, detects as the position information the current position of the mobile telephone terminal 2 by the position detector 27, and reads the personal ID, the information input reception URL, and the monitor information input data stored in the mobile telephone terminal 2 (step S61). The mobile telephone terminal 2 inserts the personal ID, the sensor measurement value, and the position information to predetermined positions of the monitor information input data, accesses to the information input reception URL, and transmits the above-mentioned data to the health care center 1 (step S62).

In the manner different from the above-mentioned operation, the host computer 10 of the health care center 1 records the received sensor measurement value in a monitor data area of the registered personal information 102, compares the recorded sensor measurement value with the individual alarm reference value obtained from the registered personal information 102 with reference to the received personal ID, and checks an abnormality in the sensor measurement value (step S63). If no abnormality is detected as a result of checking (NO in step S64), the operation comes to an end.

If an abnormality is detected in the received sensor measurement value (YES in step S64), the host computer 10 immediately calls the mobile telephone terminal 2 as a caller and transmits an abnormality notice to the mobile telephone terminal 2 (step S65). Then, the host computer 10 acquires the institution ID “102” of the Q hospital as the responsible hospital code in the registered personal information 102 with reference to the received personal ID. The host computer 10 acquires contact address information “Y” of the Q hospital from of the registered institution information 103 with reference to the institution ID “102”. Next, the host computer 10 calls the Q hospital by the contact address information “Y” and transmits to the Q hospital the abnormality notice, the position information, the personal information, and the sensor measurement value with respect to the mobile telephone terminal 2 as a caller (step S66). In the foregoing, “the Q hospital is called” in the step S66. However, depending upon the abnormality, it is possible to simultaneously request an ambulance to be sent and to inform the Q hospital that the ambulance has also been requested.

By the above-mentioned step S65, the mobile telephone terminal 2 receives an emergency call by the abnormality notice and responds to the emergency call so that an alarm announcement is immediately received by an alarm page and an alarm sound (step S67). In the Q hospital called by the above-mentioned step S66, the content of the received information is displayed by responding to the abnormality notice (step S68) so that the content can be confirmed. As a result of checking the content, the Q hospital takes appropriate measures, such as a request for an ambulance, a request for treatment by another hospital near to the patient, a notification to the patient about such request, and an advice to the patient about treatment.

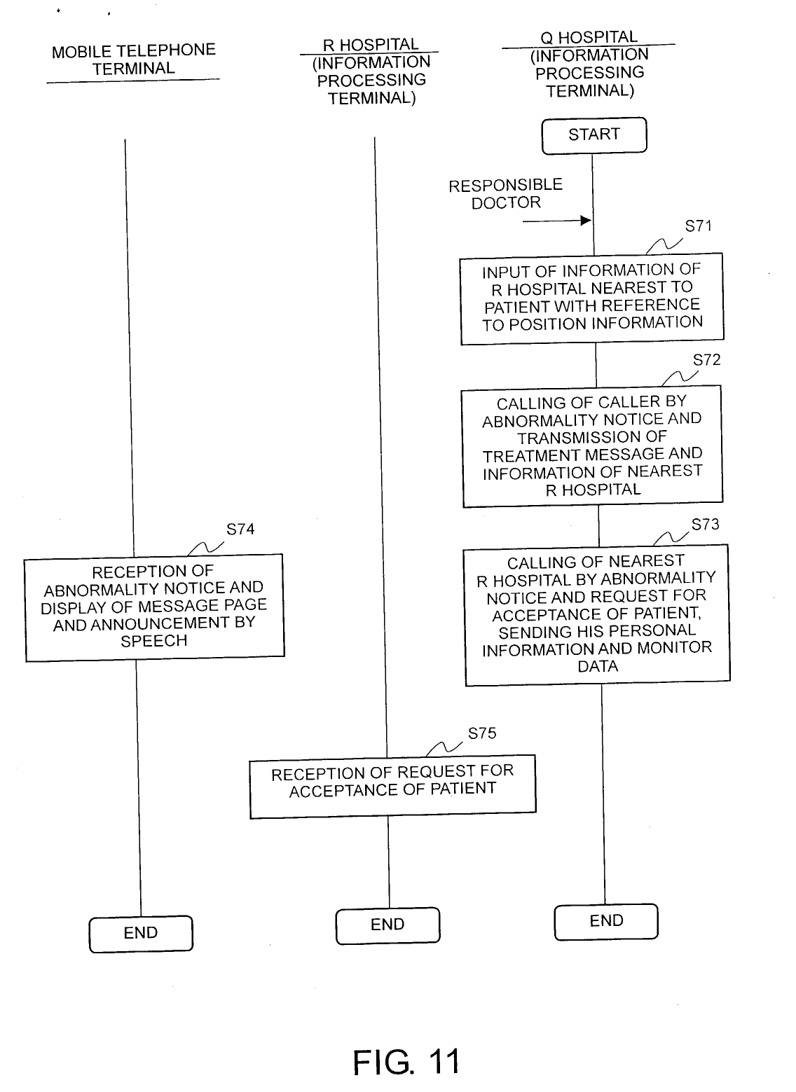

Next referring to FIG. 11, description will be made of an operation of recommending to the patient an R hospital as a nearest hospital, following the steps in FIG. 10.

It is assumed that the person in charge in the Q hospital supplied with the abnormality message reviews the information page and decides to recommend a nearest hospital to the patient. In this event, the R hospital which is located nearest and adapted to deal with an abnormal item or items can be selected from the registered institution information 103 of the health care center 1 with reference to the position information. Therefore, the information of the R hospital is supplied to the Q hospital (step S71) and the operation is started. Specifically, the information processing apparatus of the Q hospital calls the mobile telephone terminal 2 as a caller by an abnormality notice and transmits a treatment message and the information of the R hospital located nearest (step S72). Then, the Q hospital calls the R hospital by a predetermined abnormality notice and requests to receive the patient, sending the personal information and the monitor data of the patient (step S73).

By the above-mentioned step S72, the mobile telephone terminal 2 receives an emergency call by the abnormality notice and responds to the emergency call so that an alarm announcement by an emergency message on the display window and an alarm sound is immediately received (step S74). The R hospital called by the above-mentioned step S73 responds to the abnormality notice and accepts the request (step S75). The R hospital accepts to examine the patient with reference to the content of the received information to execute an optimal treatment. Thus, by the above-mentioned health care service system, the patient requiring an urgent treatment upon occurrence of an abnormality can immediately be treated in an appropriate manner. It is therefore possible to realize the health care service of a high quality.

In the foregoing description, each information processing terminal is directly connected to the Internet. Alternatively, each information processing terminal may be connected to the Internet through any other network as far as each information processing terminal can be called by an Internet function or an electronic mail.

In the foregoing description, the mobile telephone terminal has the position detector to obtain the position information. Alternatively, if the mobile telephone network has a position detection system for mobile communication terminals as disclosed in Japanese Unexamined Patent Publication No. 2001-330657 (JP 2001-330657 A), it is possible for the host computer of the health care center to identify the mobile telephone terminal, for example, by the telephone number or the mail address and to directly obtain the position information from the position detection system. In this case, the mobile telephone terminal need not have the position detector.

Although the description has been made in conjunction with the functional blocks and the steps illustrated in the figure, the functions may be distributed in different manners by separation and combination and the order of the steps may be changed as far as the above-mentioned functions are satisfied. Thus, this invention is not restricted to the foregoing description and is applicable to any health care service utilizing a mobile telephone terminal.

As described above, upon detection of an abnormality in the sensor measurement value supplied from the mobile telephone terminal carried by the patient, the host computer of the health care center immediately notifies the abnormality to the mobile telephone terminal. Thus, according to this invention, an appropriate action can be taken against the abnormality in a short time following occurrence of the abnormality and the patient carrying the mobile telephone terminal can wait a next action with feeling of relief.

In particular, supplied with the sensor measurement value transmitted by operating the emergency button of the mobile telephone terminal, the host computer immediately notifies the mobile telephone terminal as the caller that the emergency notice is received. Furthermore, the host computer notifies whether the abnormality occurs or not. Therefore, the degree of feeling of relief of the patient is further increased.

In case where a plurality of ambulance departments or a plurality of hospitals are registered, it is possible for the host computer to acquire the position information of the mobile telephone terminal and to call the nearest appropriate one immediately after detection of the abnormality in health of the patient so as to arrange a necessary action or treatment. Thus, in case of emergency, a variety of measures can be taken more and more quickly.

What is claimed is:

1. A health care service system in which an individual carrying a sensor for health care and having a mobile telephone terminal connected to said sensor and a health care service institution such as a hospital are preliminarily registered in a host computer of a health care center, said host computer of said health care center receiving and monitoring a sensor measurement value measured by said sensor and contained in data transmitted from said mobile telephone terminal through a communication network;
the host computer of said health care center preliminarily storing a reference value for each item monitored by said sensor, comparing said sensor measurement value and said reference value upon reception of said sensor measurement value from said mobile telephone terminal, and, upon detecting an abnormality, transmitting an abnormality warning to said mobile telephone terminal and the above-mentioned data to said health care service institution preliminarily registered and requesting said health care service institution to deal with the abnormality.

2. A health care service system as claimed in claim 1, wherein:
said health care service institution is a responsible hospital for said individual or an emergency hospital located in or around an area where said individual is present.

3. A health care service system in which an individual carrying a sensor for health care and having a mobile telephone terminal connected to said sensor and a health care service institution such as a hospital are preliminarily registered in a host computer of a health care center, said host computer of said health care center receiving and monitoring a sensor measurement value measured by said sensor and contained in data transmitted from said mobile telephone terminal through a communication network;
the host computer of said health care center preliminarily storing a reference value for each item monitored by said sensor, comparing said sensor measurement value and said reference value upon reception of said sensor measurement value from said mobile telephone terminal, transmitting, upon detecting an abnormality, an abnormality warning to said mobile telephone terminal and the above-mentioned data to said health care service institution preliminarily registered, and requesting said health care service institution to deal with the abnormality;
the mobile telephone terminal having an emergency report button for transmitting an emergency report when it is operated, said mobile telephone terminal transmitting, as the above-mentioned data, said sensor measurement value together with said emergency report when said emergency report button is operated by said individual;
the host computer immediately sending back, upon reception of the data including said emergency report, an acknowledgement of reception of said emergency report to said mobile telephone terminal, comparing said sensor measurement value and said reference value, informing, upon detecting no abnormality, said mobile telephone terminal as a caller of no abnormality being detected with respect to said emergency report, and, upon detection of an abnormality, transmitting the above-mentioned data to said health care service institution preliminarily registered and requesting said health care service institution to deal with said emergency report from said mobile telephone terminal.

4. A health care service system as claimed in claim 3, wherein:
said health care service institution is a responsible hospital for said individual or an emergency hospital located in or around an area where said individual is present.

5. A health care service system as claimed in claim 3, wherein:
said host computer calls said mobile telephone terminal as an emergent abnormality to warn the abnormality and notifies the situation to said health care service institution preliminarily registered to request a countermeasure against the situation, in case where no sensor measurement value is contained in said data.

6. A health care service system as claimed in claim 3, wherein:
said host computer of said health care center preliminarily registers a plurality of institutions as said health care service institution for said individual;
said mobile telephone terminal having position detecting means for detecting a current position thereof as said current position information, said mobile telephone terminal transmitting, as said data, said current position information together with said sensor measurement value to said host computer;
said host computer selecting as a selected institution, upon detection of said abnormality, one of said institutions which is nearest to the current position and which is relevant to the abnormality being detected, said host computer transmitting the data from said mobile telephone terminal to said selected institution to request an appropriate action.

7. A health care service system as claimed in claim 6, wherein:
said position detecting means detects the current position of said mobile telephone terminal as the current position information by the use of the GPS (Global Positioning System).

8. A health care service system as claimed in claim 6, wherein:
said plurality of institutions include a responsible hospital for said individual, an emergency hospital located in or around an area where said individual is present, and an ambulance department located in or around the area where said individual is present.

9. A health care service system as claimed in claim 3, wherein:
said host computer of said health care center preliminarily registers a plurality of institutions as said health care service institution for said individual;
said host computer obtaining, upon detection of said abnormality, a current location of said mobile telephone terminal as current position information from a mobile terminal position detecting system of a mobile telephone network, said host computer selecting as a selected institution one of said institutions which is nearest to the current position and which is relevant to the abnormality being detected, said host computer transmitting the data from said mobile telephone terminal to said selected institution to request an appropriate action.

10. A health care service system as claimed in claim 9, wherein:
said mobile terminal position detecting system serves to provide position information obtained by calculating a current position of a mobile telephone terminal specified in said mobile telephone network on the basis of measurement by said plurality of base stations, said host computer directly obtaining said position information from said mobile communication terminal position detecting system.

11. A health care service system as claimed in claim 9, wherein said plurality of institutions include a responsive hospital for said individual, an emergency hospital located in or around an area where said individual is present, and an ambulance department located in or around the area where said individual is present.
